(19) United States
(12) Patent Application Publication
(10) Pub. No.: US 2015/0308484 A1
(43) Pub. Date: Oct. 29, 2015

(54) Decorative Functional Nuts and Bolts with a Method of Manufacture

(71) Applicant: Wagner Dubowski, Scotch Plains, NJ (US)

(72) Inventor: Wagner Dubowski, Scotch Plains, NJ (US)

(21) Appl. No.: 14/699,120

(22) Filed: Apr. 29, 2015

Related U.S. Application Data
(60) Provisional application No. 61/985,836, filed on Apr. 29, 2014.

(51) Int. Cl. F16B 37/14

(52) U.S. Cl. CPC F16B 37/14

(57) ABSTRACT

Decorative solid piece fasteners and matching socket wrenches are provided. The decorative fastener with profiles in all three dimensions may be bolts or lock nuts. The fasteners may be used anywhere where a regular bolt head is not preferred to be visible. The fasteners may be used as decorative accessories in motorcycles or automobiles. The fasteners can be disconnected only with the matching socket and therefore the sockets may be disconnected only by the person who has the right socket and thus the fasteners have antitheft features. A method to make the fasteners is also provided.

### CLAIM OF PRIORITY

This application claims priority from U.S. Provisional Application No. 61/985,836, filed on Apr. 29, 2014, the contents of which are hereby incorporated by reference.

### FIELD OF THE INVENTION

The field of the invention relates generally to decorative nuts and bolts, in particular as accessories for motorcycles, automobiles, and items such as eyeglasses and guitars. The invention also relates to nuts and bolts with anti-theft features. The invention also relates to methods to make one piece decorative functional bolts and nuts. Further, the invention relates to a fastener with profiles in all 3 dimensions.

### BACKGROUND OF THE INVENTION

The concept of covering bolt heads in places where they are visible is known in the art and often times decorative covers are used. Decorative covers for bolt heads and decorative nuts are used especially in motor vehicles, for example in car wheels or license plates. Decorative bolt head covers are also known as motorcycle accessories.

### Review of Related Technology:

US design patent number U.S. D5158, 366 discloses a decorative lug bolt. The bolt is a regular hex bolt and the decorative part is on top of the hexagonal portion.

U.S. patent application publication US 2008/0292428 discloses a two-piece, decorative fastener assembly for securing a license plate to a vehicle. The decorative fastener includes a threaded fastener for securing the license plate to the vehicle and a decorative cover that can be connected directly to the head portion of the threaded fastener.

U.S. patent application publication US 2008/0286071 discloses a decorative fastener assembly having a fastener with a receiving chamber into which a decorative member is to be attached.

U.S. patent application publication 2005/0254920 discloses a cover for bolt heads of motorcycles where the cover has a skirt and a recess and the recess is adapted to receive a color matched object.

U.S. Pat. No. 8,366,362 discloses a nut and bolt cover apparatus made from three pieces. A cover piece may be placed over a nut and may have an adapter piece placed over the cover. An exterior cover may be releasably attached to the adapter piece and may squeeze a portion of the adapter piece as the exterior cover is releasably attached to the adapter. Squeezing the adapter piece compresses the cover piece and causes the cover piece to grip the nut of a nut and bolt assembly while the adapter piece grips the cover piece.

U.S. Pat. No. 5,980,178 discloses ornamental nuts and bolts where an ornamental seal is inserted into a recess formed at the rearward potion of a nut body or into a recess formed in a head of a bolt body.

U.S. Pat. No. 4,8990,967 discloses a decorative cover for bolts and nuts.

European patent publication EP2172661 discloses a wheel bolt having a decorative aluminum head attached to the threaded portion of the bolt.

Japanese patent publication JP2002266832 discloses a bolt cap having a decorative member mounted on an adhesive surface.

Japanese patent publication JP2002021832 discloses a fastener formed of a bolt and a nut with a decorative surface part in the surface thereof with an engaging recessed part having a functional shape inside of an upper part of a through screw hole and a disconnecting jig engaging the recessed part of the decorative nut.

Accordingly, various devices are known in the art. The devices known in the art generally include bolt head covers, bolt heads that include a recess where a cover is to be inserted, and bolt heads screwed or otherwise attached to the threaded bolt stud. Where a one piece bolt with decorative bolt head is provided, the decorative part is on top of a regular hexagonal head and a wrench is used to attach/detach the bolt. Usually the decoration is provided as an attachment on the hexagonal head, for example by attaching the decoration with adhesive or by having a recess in the head where the decorative part attaches to. An alternative to the hexagonal head is a bolt head with a recess for a hex key for attachment/detachment. Accordingly, anyone having a regular wrench or hex key can open and remove such decorative bolts. Moreover, making such decorative bolts is not inexpensive and making individualized bolts would be even less economic. The structure and means of operation of the present disclosure are substantially different from any prior art disclosures and this invention solves the problems and flaws of the prior art. At least one embodiment of this invention is presented in the drawings below and will be described in more detail herein.

### SUMMARY OF THE INVENTION

The present invention generally provides a solid one piece decorative and functional fastener with profiles in all three dimensions, a unique disconnecting wrench and a means to assemble the fastener with the decoration being in a desired predetermined position.

The present invention provides decorative fastener with profiles in all three dimensions with unique disconnecting means and thus also means to prevent unauthorized disassembly of the decorative fasteners. The decorative design may be unique and the fasteners thus custom made.

The present invention also provides for a method to make the decorative functional fastener with profiles in all three dimensions and the matching wrench.

Generally, the present invention is described in at least one embodiment as a decorative solid piece fastener consisting of a head having a design, and a threaded shaft or a threaded recess. In one embodiment there is provided a wrench socket for fastening a decorative solid piece fastener with a head having a design, wherein the socket comprises a cylindrical portion having a recess dimensioned to snugly fit the head of the fastener.

In still another embodiment there is provided a kit comprising a decorative solid piece fastener with profiles in all three dimensions with a head having a design and one or more spacers, wherein the design has a vertical and a horizontal axis and the fastener is positioned with the one or more spacers so that the vertical axis is vertically positioned and the horizontal axis is horizontally positioned.

In yet another embodiment there is provided a decorative attachment kit comprising: one or more decorative solid piece fastener with profiles in all three dimensions having a head, said head being a design, and a threaded shaft or a threaded recess; one or more wrench sockets where the socket comprises a cylindrical portion having a recess dimensioned to snugly fit the head of the bolt; and a multitude of spacers to lock the bolt at a position where the design is in preferred position.

In yet another embodiment there is provided a method to manufacture a decorative functional solid piece fastener with profiles in all three dimensions, wherein the method comprises the steps of: a) providing a design for a decorative head in CAD format; b) providing a blank with a shaft and a head; c) machining/milling the head with CNC machines; and d) finalizing the resulting fastener.

It is an objective of this invention to provide decorative, unique fastener with profiles in all three dimensions.

It is another objective of this invention to provide functional and decorative, economic nuts and bolts for various purposes, preferably for decorative and functional use in motorcycle, car wheels, license plates or other vehicle parts.

It is an object to provide individualized decorative fasteners.

It is yet another object to provide a kit including individual decorative fastener with profiles in all three dimensions, and means to assemble the fasteners as well as means to position the decoration in a predetermined position.

It is still another object of this invention to provide an economic method to make individualized decorative fasteners, such as nuts and bolts.

It is yet another object of this invention to provide individualized decorative fastener with profiles in all three dimensions that cannot be disconnected with regular wrenches but an individualized wrench is required. Thus the invention also provides a theft prevention mechanism for decorative fasteners.

### BRIEF DESCRIPTION OF THE DRAWINGS

FIG. 1 is a perspective view of an individualized decorative bolt according to this invention. The bolt head in this embodiment is a skull.

FIGS. 2A-2C shows alternative embodiments of the present invention.

FIG. 3 shows an embodiment the bolt of the present invention and the socket wrench adapter of the present invention.

FIG. 4 shows a side view of an embodiment the bolt of the present invention and the socket wrench adapter of the present invention n embodiment.

FIG. 5 shows a side view the bolt of the present invention and an extended socket wrench adapter of the present invention.

FIGS. 6A-6D show spacers to be used with the decorative bolt of the present invention.

FIGS. 7A and 7B show an embodiment of the individualized decorative lock nut of the present invention.

### DETAILED DESCRIPTION OF THE DRAWINGS

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

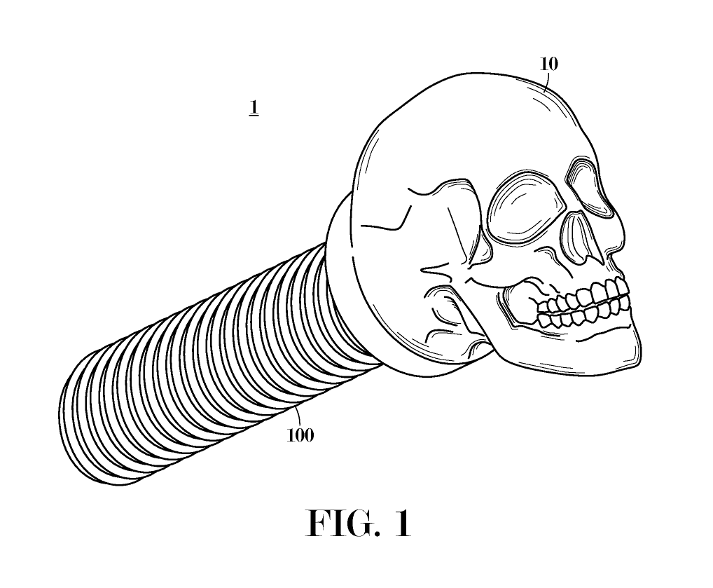

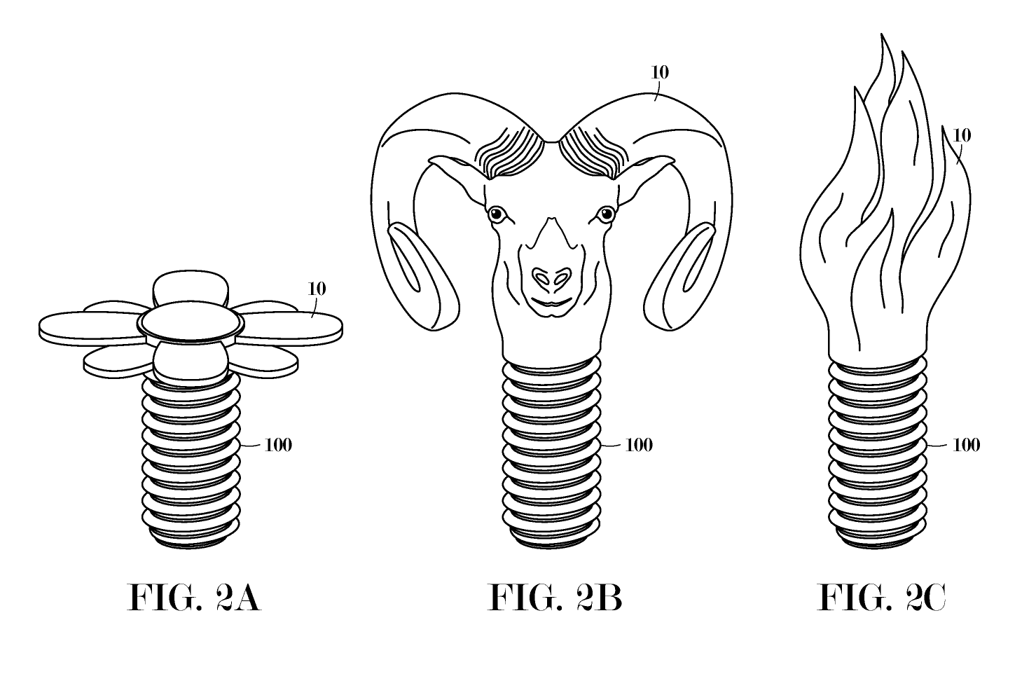

Referring now to FIG. 1, a bolt 1 having an individualized decorative head 10 and a threaded shaft 100 is shown. The bolt is one solid unit and importantly it does not have a hexagonal part for disconnecting or attaching with a regular wrench. In FIG. 1, the decorative head is a skull, but the decorative head can be in any other desired form. In FIGS. 2A-2C, a flower, a ram's head and a flame are shown. Generally, examples of decorative heads are animal heads, such as dog heads, cat heads, snake heads, spiders. Other examples could be designs, logos, alphabets and numbers. A skilled artisan will realize that the design can be anything and any variations of designs will fall under the scope of this invention.

Referring now to FIGS. 2A-2C, alternative embodiments of the present invention are shown. As noted, these show some preferred embodiments wherein individualized decorative head 10 is shaped to resemble different objects. It should be noted that a multitude of different individualized decorative heads can be created, limited only by the manufacturer's creativity and any design constraints imposed by the materials used to construct the present invention.

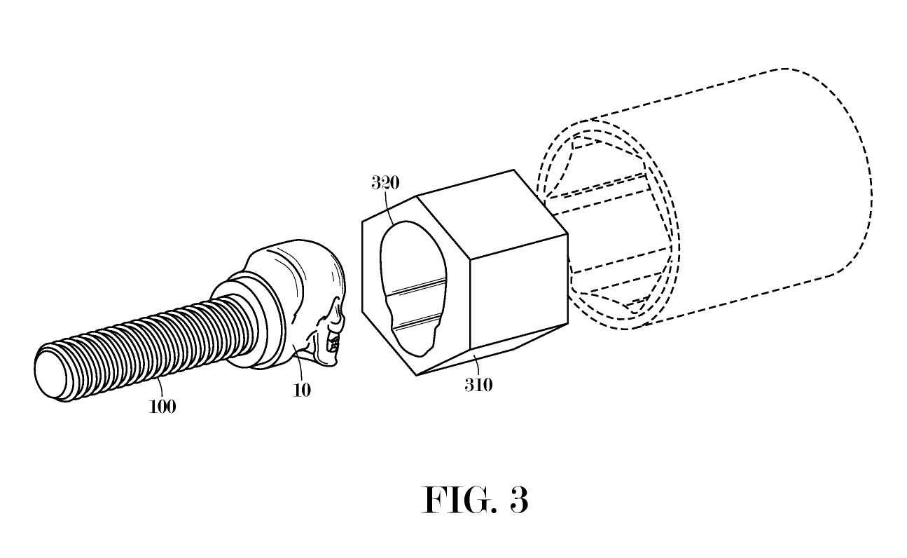

Referring to FIG. 3, an embodiment the bolt of the present invention and the socket wrench adapter of the present invention are provided for. Here, threaded shaft 100 and individualized decorative head 10 are shown. Also shown is socket wrench adapter 310, which is equipped with complimentary shaped groove 320. As can be seen, individualized decorative head 10 can be inserted into socket wrench adapter 310 via complimentary shaped groove 320. The outer rim of socket wrench adapter 310 is shaped substantially as a hexagon, such that it will interface with standardized socket wrenches. This has the benefit of allowing a purchaser of the present invention to use their existing tools to manipulate the present invention as opposed to buying an entire specialized toolset for each individualized decorative head 10.

In an alternative embodiment, it is illustrated how it is important to have a system to position the bolt in predetermined position. The bolt head in this case is not symmetric but has a vertical axis 0-180 and a horizontal axis 90-270. In order to have the individualized decorative bolt head (here a skull) in proper orientation the user needs to have a means to position the 0-180 axel in vertical position and the 90-270 axis in horizontal position.

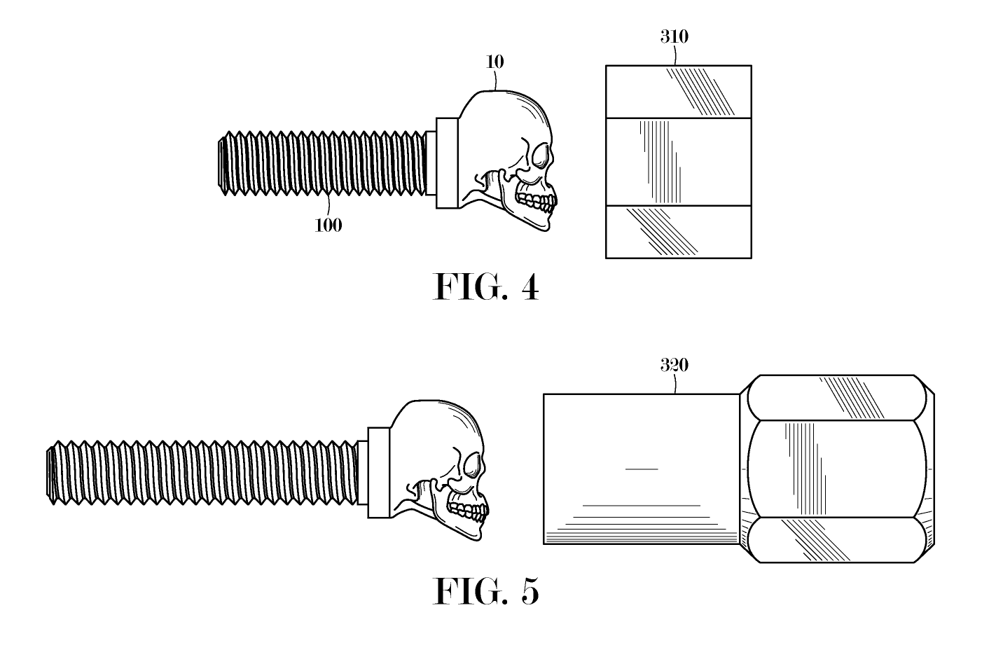

FIG. 4 shows a side view of an embodiment the bolt of the present invention and the socket wrench adapter of the present invention n embodiment. This figure shows individualized decorative head 10, threaded screw 100, and socket wrench adapter 310.

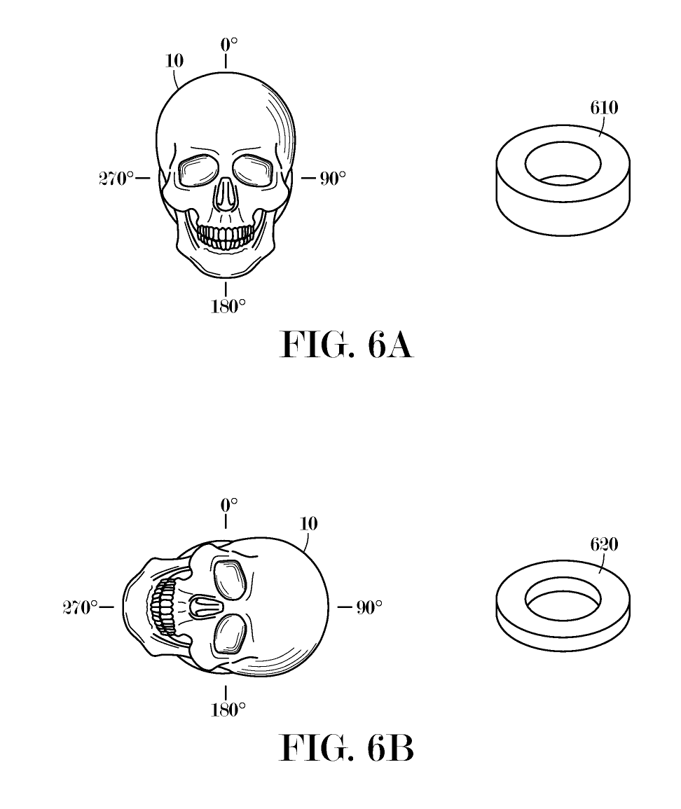

FIG. 5 shows a side view the bolt of the present invention and an extended socket wrench adapter of the present invention. This view is intended to highlight that socket wrench adapters of a variety of depths may be used so that a wider variety of fasteners may be replaced with the present invention. Specifically, extended socket wrench adapter 310 is shown, but a number of not expressly listed sizes and orientations may be used.

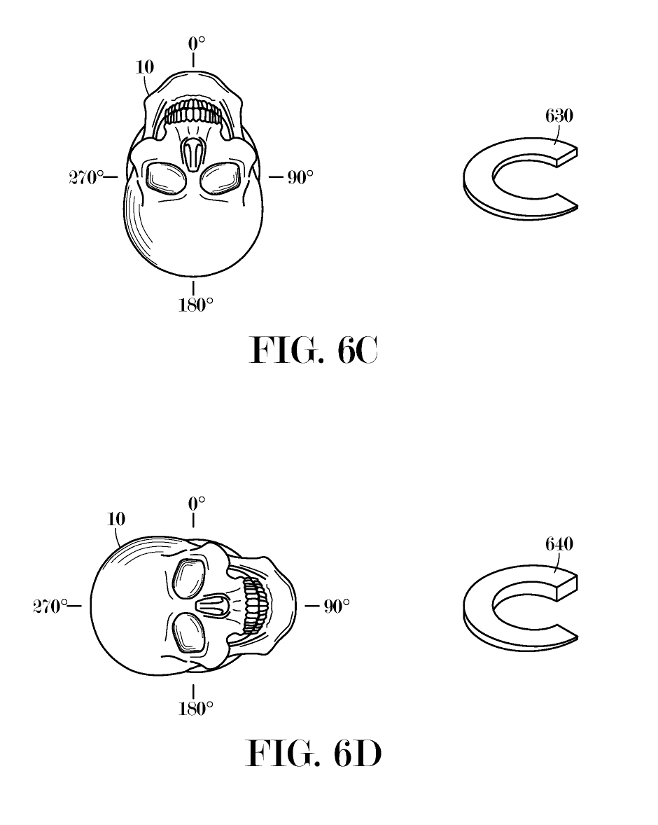

Referring to FIGS. 6A-6D spacers to be used with the decorative bolt of this invention to position the 0-180 and 90-270 axes vertically and horizontally are provided for. The means for positioning is one or more spacers 4. The spacers may be ring like washers as shown by washers 610 and 620, or these washers may be partially open rings as shown by washers 630 and 640. The spacers may be provided in different thicknesses to achieve the correct positioning of the two axes or the spacers may come in one thickness and the user may use multiple spacers to position the two axes correctly. In case of a ring like spacer as shown in FIGS. 6A and 6B, the threaded shaft of the bolt is to be inserted through the hole in the spacer. In order to add more spacers or change a thinner or thicker spacer the user has to disconnect the bolt and change the spacers. The spacers with an opening as shown in FIGS. 6C and 6D may be added, removed or changed without removing the bolt from its place. Generally speaking the thickness of a spacer is 0.001″ up to 1 revolution of a thread in 0.001″ increments. The spacers are made of same material as the screw or the nut.

In an alternative embodiment, the socket has a generally cylindrical portion which has a female recessed opening sized to match the individualized decorative head 101. Note that for alternative embodiments of individualized decorative head 10, complimentary shaped groove 320 will be shaped to receive these alternative embodiments.

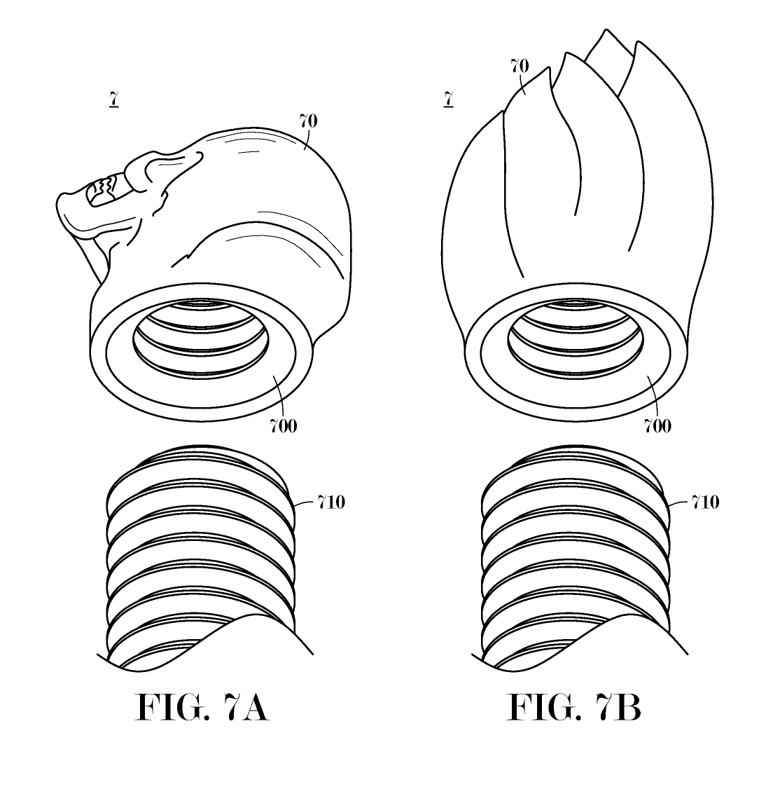

Now referring to FIG. 7A, an individualized decorative lock nut 7 is shown. The nut has an individualized decorative head 70 and a threaded female receptacle 700 for a threaded bolt shaft 710. The nut is one solid unit and importantly it does not have a hexagonal part for disconnecting or attaching with a regular wrench. In FIGS. 7A and 7B, the decorative nut head is shown as a skull design and as a flame design, but the decorative head can be in any other desired form. Examples of decorative heads are animal heads, such as dog heads, cat heads, snake heads, spiders. Other examples could be alphabets, logos and numbers. A skilled artisan will realize that the design can be anything and any variations of designs will fall under the scope of this invention.

In order to detach a nut head such as shown in FIG. 7 a socket matching the nut head 70 is provided. The socket shown in FIGS. 3-5 are capable of fitting with the skull design nut head shown in FIGS. 7A and 7B, provided that all the dimensions of the head 70 are same as those shown in FIG. 1. For the flame design nut head a socket with matching female recessed opening would be required.

According to a preferred embodiment the decorative head may have a diameter between 2 mm to 20 cm, preferably between 5 mm and 10 cm, and most preferably between 10 mm and 5 cm. Smaller nuts and bolts would be used for example in eyeglasses while larger ones can be used as motorcycle or automobile accessories. The skilled artisan would realize that the nuts and bolts can be of any size depending on the object where they are used.

According to a preferred embodiment the invention provides a kit including a plurality of decorative nuts and/or decorative bolts, one or more matching sockets to be attached to a wrench handle and a multitude of spacers for positioning the decorative head in desired position.

According to a preferred embodiment of this invention a method to manufacture nuts and bolts with decorative heads is provided. The decorative heads may be according to customer's unique design or the heads may be according to any other design.

According to a preferred embodiment the threading in the bolt shaft or in the nut recess may be selected from the below table:

Thread Sizes

| ISO | Tap | American | Tap |
|---|---|---|---|
| Thread | Drill | Standard Thread | Drill |
| Size | (mm) | Size | (in) |
| M1 × | 0.75 | 0-80 | 3/64 |
| 0.25 | | | |
| M1.1 × | 0.85 | 1-64 | 53 |
| 0.25 | | | |
| M1.2 × | 0.95 | 1-72 | 53 |
| 0.25 | | | |
| M1.4 × | 1.10 | 2-56 | 51 |
| 0.3 | | | |
| M1.6 × | 1.25 | 2-64 | 50 |
| 0.35 | | | |
| M1.8 × | 1.45 | 3-48 | 5/64 |
| 0.35 | | | |
| M2 × 0.4 | 1.60 | 3-56 | 46 |
| M2.2 × | 1.75 | 4-40 | 43 |
| 0.45 | | | |
| M2.5 × | 2.05 | 4-48 | 42 |
| 0.45 | | | |
| M3 × 0.5 | 2.50 | 5-40 | 39 |
| M3.5 × | 2.90 | 5-44 | 37 |
| 0.6 | | | |
| M4 × 0.7 | 3.30 | 6-32 | 36 |
| M4.5 × | 3.70 | 6-40 | 33 |
| 0.75 | | | |
| M5 × 0.8 | 4.20 | 8-32 | 29 |
| M6 × 1 | 5.00 | 8-36 | 29 |
| M7 × 1 | 6.00 | 10-24 | 25 |
| M8 × | 6.80 | 10-32 | 21 |
| 1.25 | | | |
| M9 × | 7.80 | 12-24 | 17 |
| 1.25 | | | |
| M10 × | 8.50 | 12-28 | 15 |
| 1.5 | | | |
| M11 × | 9.50 | ¼-20 | 7 |
| 1.5 | | | |
| M12 × | 10.20 | ¼-28 | 3 |
| 1.75 | | | |
| M14 × 2 | 12.00 | 5/16-18 | F |
| M16 × 2 | 14.00 | 5/16-24 | I |
| M18 × | 15.50 | ⅜-16 | 5/16 |
| 2.5 | | | |
| M20 × | 17.50 | ⅜-24 | Q |
| 2.5 | | | |
| M22 × | 19.50 | 7/16-14 | U |
| 2.5 | | | |
| M24 × 3 | 21.00 | 7/16-20 | W |
| M27 × 3 | 24.00 | ½-13 | 27/64 |
| M30 × | 26.50 | ½-20 | 29/64 |
| 3.5 | | | |
| M33 × | 29.50 | 9/16-12 | 31/64 |
| 3.5 | | | |
| M36 × 4 | 32.00 | 9/16-18 | 33/64 |
| M39 × 4 | 35.00 | ⅝-11 | 17/32 |
| M42 × | 37.50 | ⅝-18 | 37/64 |
| 4.5 | | | |
| M45 × | 40.50 | ¾-10 | 21/32 |
| 4.5 | | | |
| M48 × 5 | 43.00 | ¾-16 | 11/16 |
| M52 × 5 | 47.00 | ⅞-9 | 49/64 |
| M56 × | 50.50 | ⅞-14 | 13/16 |
| 5.5 | | | |
| M60 × | 54.50 | 1″-8 | 7/8 |
| 5.5 | | | |
| M64 × 6 | 58.00 | 1″-14 | 15/16 |
| M68 × 6 | 62.00 | | |

The decorative fastener with profiles in all three dimensions are preferably used in vehicles, preferably in motorcycles and automobiles. When used in motorcycles the fasteners are used anywhere where the bolt or nut head is visible. In automobiles the fasteners may be used similarly everywhere where the bolt or nut heads would be visible, such as in wheels or license plate attachments. However, the decorative fasteners of this invention may be used anywhere where a bolt or nut head is visible and there is a wish to cover the visible head. Such visible heads may be on eyeglasses, guitars, walls, or in any kind of device. Moreover, because the fasteners of this invention cannot be opened with regular wrenches, the kit including the decorative fasteners and the matching wrench sockets is an essential tool to prevent theft because to disconnect the nut or bolt one needs to have the matching socket.

The manufacturing process according to this invention provides the decorative nut or decorative bolt in one piece. The decorative fastener with profiles in all three dimensions is machined complete on Computer Numeric Control (CNC) machines. The designs may be provided by the customer and in this case the fasteners have truly unique head designs. Alternatively a head design may be one captured from public domain and mass manufactured. The manufacturing process in both cases uses computer-aided design (CAD) and computer-aided manufacturing (CAM) programs. The programs produce a computer file that is interpreted to extract the commands needed to operate a particular machine via a post processor, and then loaded into the CNC machines for production. The CNC machines may be mills or lathes.

According to a preferred embodiment of manufacturing the decorative fastener with profiles in all three dimensions a turn blank includes a shaft with threads and a head with enough material to be cut into shape of the design on a 3 axis, 4 axis or 5 axis milling machine (CNC) or screws to be machined complete on a CNC lathe with live tooling or a CNC Swiss turn with live tooling.

According to another preferred embodiment a non-custom/mass produced design may be used and the fasteners are manufactured by stamping or forging the design on the head part. In doing so a punching machine press or stamping press may be used. Alternatively CNC machines may be used similarly as described above.

Once the fastener with profiles in all three dimensions are produced the design will be finalized by polishing, chroming, anodizing, heat treating, hard coat anodizing, powder coating painting, or any other feasible means.

According to a preferred embodiment the fasteners are made of steel, aluminum, brass, copper, plastics, nylon, gold, silver, platinum or iron. According to one preferred embodiment the steel is stainless steel, alloy steel, tool steel or carbon steel.

What is claimed is:

1. A decorative fastener comprising of :
a head having a design; and
a threaded shaft or a threaded recess.

2. The fastener of claim 1, wherein the fastener is a bolt or a lock nut having profiles in all three dimensions.

3. A wrench socket for fastening a decorative fastener of claim 1, wherein the socket comprises a cylindrical portion having a recess dimensioned to fit the head of the fastener.

4. A kit comprising a decorative fastener comprising:
a head having a design and a threaded shaft or a threaded recess; and
one or more spacers,
wherein the design has a vertical and a horizontal axis and the fastener is positioned with the one or more spacers so that the vertical axis is vertically positioned and the horizontal axis is horizontally positioned.

5. The kit of claim 4, wherein one or more spacers are used to position the fastener.

6. The kit of claim 4, further comprising a socket wrench adapter.

7. The kit of claim 4, further comprising an extended socket wrench adapter.

8. The fastener of claim 1, wherein the fastener is made of steel, aluminum, brass, copper, plastics, nylon, gold, silver, platinum, iron , or any combination thereof.

9. The fastener of claim 1, wherein a decorative head features a skull, an animal head, an animal, a human figure, designs, logos, letters, numbers, or a combination thereof.

10. The fastener of claim 1, wherein the decorative head features a skull.

11. The fastener of claim 2, wherein the decorative head features a skull.

12. A decorative attachment kit comprising:
one or more decorative solid piece fasteners having a head, said head being a design, and a threaded shaft or a threaded recess;
one or more wrench sockets where the socket comprises a cylindrical portion having a recess dimensioned to fit the head of the bolt; and
a multitude of spacers to lock the bolt at a position where the design is in preferred position.

13. The kit of claim 12, wherein the fasteners are bolts or lock nuts having profiles in all three dimensions.

14. The kit of claim 12, wherein the design is a skull-design.

15. The kit of claim 12, wherein the spacers are closed rings or rings with an opening.

16. The kit of claim 15, wherein the spacers are of the same thickness.

17. The kit of claim 15, wherein the spacers have different thickness.

18. A method to manufacture a decorative solid piece fastener, wherein the method comprises the steps of:
a) providing a design for a decorative head in CAD format;
b) providing a blank with a shaft and a head;
c) machining or milling the head with CNC machines; and
d) finalizing the resulting fastener with high polish, chrome, a hard coat, electropolish, or an anodized finish.

19. The method of claim 18, further comprising the step of:
manufacturing a matching wrench socket where the socket has a recess snugly fitting on the decorative head, wherein the socket is machined or milled with CNC machine and the recess is formed based on the CAD design of step a).

20. The method of claim 18, wherein the design is a skull design.
